(19) United States
(12) Patent Application Publication
(10) Pub. No.: US 2010/0000227 A1
(43) Pub. Date: Jan. 7, 2010

(54) AIR INTAKE FOR AN AIRCRAFT TURBINE ENGINE

(75) Inventors: Alain Porte, Colomiers (FR); Jacques Lalane, SaintOrens De Gameville (FR); Fabrice Gantie, Toulouse (FR)

Correspondence Address: Dickinson Wright PLLC;James E. Ledbetter, Esq., International Square, 1875 Eye Street, N.W., Suite 1200, Washington, DC, 20006, US

(73) Assignee: AIRBUS France, Toulouse (FR)

(21) Appl. No.: 12/307,881

(22) PCT Filed: Jul. 4, 2007
(86) PCT No.: PCT/FR2007/001132

§ 371 Date: Jan. 7, 2009

(30) Foreign Application Priority Data
Jul. 12, 2006 (FR) 06 06334

(51) Int. Cl. F02C 7/20; F01D 1/02

(52) U.S. Cl. 60/796; 415/200

(57) ABSTRACT

According to the invention, the air intake (2) is made of a piece (23) of fibre/resin composite material, reinforced on the side of the flange (24) by a reinforcing ring (26).

The present invention relates to aircraft turbine engines and, more specifically, to the air intake of a turbine engine such as this.

In known turbine engines, the internal wall of the air intake and the fan casing are made of metal and the rear end of said internal wall of the air intake and the front end of said fan casing have collaborating projecting peripheral flanges so that they can be joined together using fasteners such as screws, bolts, etc., of which the axes are parallel to the longitudinal axis of the turbine engine and which pass through said flanges.

Given the mechanical, thermal and mass properties of resin/fiber composites, it would be advantageous if it were possible for said internal wall of the air intake to be produced entirely in the form of a component made of such composite. However, tests performed to these ends have not proved advantageous because, in use, the fibers delaminate at the 90° elbow between said peripheral flange and the tubular remainder of said internal wall, which delamination leads to a substantial drop in the mechanical strength of said component and even causes this component to break.

It is an object of the present invention to remedy this disadvantage.

To this end, according to the invention, the aircraft turbine engine having a longitudinal axis and comprising:
an air intake provided with a tubular internal wall; and
a fan, supplied with air by said air intake and enclosed in a casing, which is likewise tubular,
   the rear end of said internal wall of the air intake and the front end of said fan casing being respectively provided with peripherally projecting connection flanges and joined together using first fasteners such as screws, bolts or the like, which pass through said flanges and of which the axes are at least approximately parallel to said longitudinal axis of the turbine engine,
   is notable in that:
said internal wall of the air intake, including the connection flange of said rear end, is formed of a component made of a resin/fiber composite;
on the opposite side to the front end of said casing, the peripherally projecting flange of said rear end is connected to said internal wall by an at least approximately cavetto-shaped annular profile;
a reinforcing ring is attached to said rear end, said reinforcing ring espousing said at least approximately cavetto-shaped annular profile and being secured to said rear end by second fasteners the axes of which are at least approximately orthogonal to said longitudinal axis of said turbine engine; and
said reinforcing ring has said first fasteners passing through it and is pressed against said flanges.

Thus, by virtue of the shape of the composite flange and of the presence of said reinforcing ring, no delamination can occur at the elbow connecting said flange to the tubular remainder of said internal wall.

The composite may be made of carbon, glass, boron, silicon carbide, etc. fiber. However, carbon fiber is preferred. Moreover, said component made of composite may be obtained by any known method (filament winding, coiling, draping fiber or fabric prepregs, etc.).

As a preference, in order further to enhance the strength of the component made of composite, a reinforcement made of composite, that forms an integral part of said component, is provided under said reinforcing ring, that is to say that, in this location, the thickness of said component made of composite is greater than it is elsewhere.

Advantageously, said reinforcing ring is made of metal. It has been found that titanium is a particularly suitable material of which to make said reinforcing ring.

The figures of the attached drawing will make it easy to understand how the invention may be embodied. In these figures, identical references denote elements that are similar.

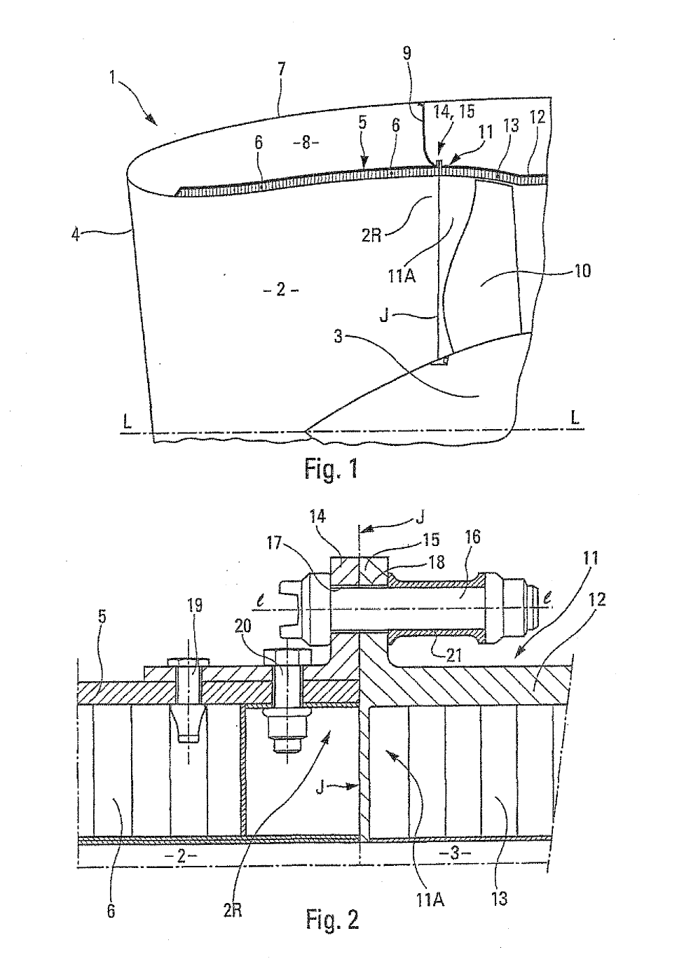

FIG. 1 shows, in partial schematic half section, the forward part of a known turbine engine.

FIG. 2 shows, also in partial schematic half section, one example of the joining-together of the rear end of the air intake and the front end of the fan casing in the known turbine engine of FIG. 1.

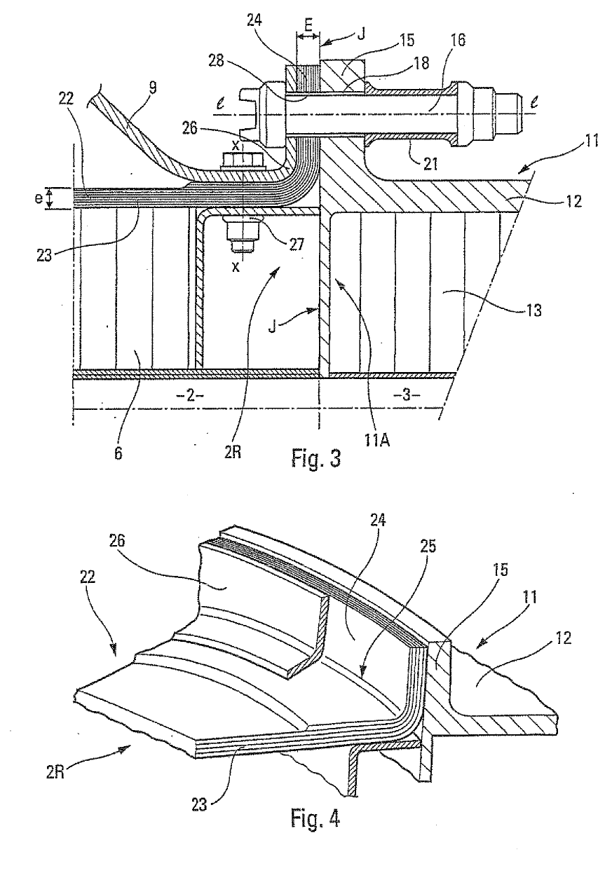

FIG. 3 shows, in a view similar to FIG. 2, an exemplary embodiment of the invention.

FIG. 4 is a perspective partial view, with cutaway, of elements of FIG. 3.

The turbine engine 1 of known type, the forward part of which is schematically and partially depicted in FIG. 1, has a longitudinal axis L-L. This forward part essentially comprises a tubular air intake 2 and a fan 3.

The tubular air intake 2 has a leading edge 4 and is provided with a metal tubular internal wall 5, for example made of aluminum, internally bearing a noise-deadening tubular covering 6. An external cowl 7 surrounds said air intake and with said internal wall 5 delimits a chamber 8 of annular cross section, closed off by an annular rear partition wall 9 at the opposite side to said leading edge 4.

The fan 3 has blades 10 and is surrounded by a fan casing 11 consisting of a metal tubular component 12, for example made of aluminum, and internally bearing a noise-deadening tubular covering 13.

The rear end 2R of the air intake 2 and the front end 11A of the fan casing 11 are joined together along a joining plane J.

As shown to a large scale in FIG. 2, the rear 2R and front 11A ends are assembled using two collaborating annular flanges 14 and 15 that project outward at the periphery of the internal wall 5 and of the tubular component 12 and which are pressed against one another by bolts 16 the axes l-l of which are parallel to the longitudinal axis L-L and which pass through opposing drillings 17 and 18 made in said flanges 14 and 15. In the known exemplary embodiment of FIG. 2, the annular flange 14 is attached to the internal wall 5 and is joined to the latter by bolts 19 and 20. By contrast, in this example, the flange 15 is machined as a single piece with the tubular component 12.

Furthermore, associated with each bolt 16 is a sleeve 21, through which said bolt 16 passes and which is secured by that bolt to the flange 15. The sleeves 21 are produced in such a way that they can undergo plastic compression in the axial direction. Thus, when a blade 10 of the fan 3 breaks and strikes the casing 11, the energy of the impact may be at least partially absorbed by the deformation of said sleeves 21.

In the exemplary embodiment according to the present invention and depicted in FIG. 3, we once again find the elements 2, 2R, 3, 6, 9, 11 to 13, 11A, 15, 16, 18, 21 and J described hereinabove with reference to FIG. 2. By contrast, the tubular internal wall 5 and the flange 14 have been omitted and are replaced by a single component 22 made of composite, preferably based on carbon fiber, comprising a tubular internal wall 23 (replacing the tubular internal wall 5) and a flange 24 (replacing the flange 14).

On the opposite side to the fan casing 11, the flange 24 is connected to the tubular wall 23 by a cavetto 25 (see also FIG. 4) . In addition, said flange 24 and the cavetto 25 are strengthened with composite, so that their thickness E is greater than the thickness e of the tubular wall 23.

A reinforcing ring 26, for example made of titanium, is attached to said component 22 made of composite in such a way as to espouse said cavetto 25, and is fastened to the latter by bolts 27 the axes x-x of which are orthogonal to said axis L-L. In addition, said reinforcing ring 26 has the bolts 16 passing through it, through holes 28 (analogous to the drillings 17), and is pressed against the flanges 15 and 24.

If appropriate, the reinforcing ring 26 may extend to form the annular rear partition wall 9 (as depicted in FIG. 3).

As a preference, the bolts 27 are of the so-called “blind bolt” type so as not to require access to the rear end 2R. Thus, the sound deadening covering 6 can be extended rearward.

It will be noted that the air intake according to the present invention has no break in impedance, thus improving the overall noise-deadening performance of the soundproofing.

1-6. (canceled)

7. An aircraft turbine engine having a longitudinal axis (L-L) and comprising:
an air intake (2) provided with a tubular internal wall; and
a fan (3), supplied with air by said air intake and enclosed in a casing (11), which is likewise tubular, the rear end of said internal wall of the air intake and the front end of said fan casing being respectively provided with peripherally projecting collaborating connection flanges and joined together using first fasteners (16) such as screws, bolts or the like, which pass through said flanges and of which the axes (1-i) are at least approximately parallel to said longitudinal axis (L-L) of the turbine engine, wherein:
said internal wall (23) of the air intake (2), including the connection flange (24) of said rear end (2R), is formed of a component (22) made of a resin/fiber composite;
on the opposite side to the front end (11A) of said casing (11), the peripherally projecting flange (24) of said rear end (2R) is connected to said internal wall (23) by an at least approximately cavetto-shaped annular profile (25);
a reinforcing ring (26) is attached to said rear end (2R), said reinforcing ring espousing said at least approximately cavetto-shaped annular profile (25) and being secured to said rear end (2R) by second fasteners (27) the axes (x-x) of which are at least approximately orthogonal to said longitudinal axis (L-L) of said turbine engine; and
said reinforcing ring (26) has said first fasteners (16) passing through it and is pressed against said collaborating flanges (15, 24).

8. A turbine engine according to claim 7, wherein said composite is based on carbon fiber.

9. A turbine engine according to claim 7, wherein under said reinforcing ring (26), the thickness (E) of said component (22) made of composite is greater than in the tubular remainder of said internal wall (23).

10. A turbine engine according to claim 7, wherein said reinforcing ring (26) is made of metal.

11. A turbine engine according to claim 10, wherein said reinforcing ring (26) is made of titanium.

12. A turbine engine according to claim 7, wherein said second fasteners (27) are blind.
